(19) United States
(12) Patent Application Publication
(10) Pub. No.: US 2018/0300744 A1
(43) Pub. Date: Oct. 18, 2018

(54) SOCIAL NETWORKING SYSTEM INCENTIVIZING TAGGING AND COMMERCIAL ENGAGEMENT METHODS

(71) Applicant: Lawrence Sowell, Coeur dAlene, ID (US)

(72) Inventor: Lawrence Sowell, Coeur dAlene, ID (US)

(21) Appl. No.: 15/489,733

(22) Filed: Apr. 18, 2017

(51) Int. Cl. G06Q 30/02; G06F 17/30; G06Q 50/00

(52) U.S. Cl. CPC G06Q 30/0239; G06Q 50/01; G06F 17/30268; G06Q 30/0277

(57) ABSTRACT

A social networking method comprising the steps of establishing an online networking environment to enable a plurality of users to engage in the sharing of media and providing a user interface in the online networking environment to enable a first user with a first option to upload a media file that may visually depict a commercially relevant material; select at least a first tag from a populated list of tags and associate said first tag with a first commercially relevant material displayed in the media file; providing the first user with a second option to create a tag associated with the displayed; and furnishing credit to users of the online networking environment that tag images with relevant links to commercially relevant material.

### CROSS-REFERENCE TO RELATED APPLICATIONS

This present disclosure claims the benefit of U.S. Provisional Application Ser. No. 61/933,308, filed on Jan. 30, 2014.

### TECHNICAL FIELD

This invention relates generally to social networking, and more particularly to incentivizing user engagement and the production of social content by commercializing user generated data within a social network, and/or with third-party websites, service providers and vendors.

### BRIEF BACKGROUND

With the proliferation of mobile devices and increased user access to the Internet, a greater contingency of “connected” users access the Internet across the world. What was once a tool used to research or send emails has now primarily become a platform for updating friends with pictures, life updates, or general feelings throughout the day.

Indeed, according to certain studies, nearly one in four people worldwide used social networks in 2013. The number of social network users around the world will rise from 1.47 billion in 2012 to 1.73 billion this year, an 18% increase. By 2017, the global social network audience will total 2.55 billion. At the same time, by the year 2015, an estimated 105 billion photos will be taken on camera phones. Social networks are big business for the various companies that create them, but despite the increased use of internet services, social networks and camera phones, currently available systems lack any direct financial incentive for users to post or share information, such as pictures.

In a typical social networking system, such as a social networking website, users compile personal information and then establish connections with other users of the social networking system. Because the users provide personal information, a social networking system can collect and obtain useful information about its users. More importantly, the social networking system can obtain information regarding subsets of users, for example based on criteria such as a user's location, interests, and various other demographic pieces.

However, presently available social networking systems do not financially incentivize users to post or interact with the social networking system. Indeed, presently available social networking systems may sometimes exhaust users because there is no incentive for users to continue to use them except for sharing news or media or keeping up with their network's activities. Furthermore, currently available social networks do not incentivize deeper layer interaction on networks, such as via tagging uploaded media in a commercial manner. Currently available social networking systems also do not provide rich information regarding product purchases, nor the ability to track tags from their creation to the most recent transaction based upon a respective tag.

Similarly vendors and service providers, at best, are limited to having a mere presence on social networks. Businesses may attempt to market themselves by getting people to follow their updates, but presently available networks offer an inferior experience as there is no way for a user or a business to reliably receive compensation for its use or sharing on the network. Additionally, businesses achieve lower levels of user-engagement because the most a business can do to interact with its users (i.e. its customers) on the presently available social networking systems is to receive “likes” or similar “favorite” calls by the users. Finally, presently available systems do not result in sales or transactions of goods and services on the social network itself.

Thus the current situation may often times result in businesses or users leaving the social network altogether because their respective use is not financially incentivized. Therefore, there is a present and impending need for a social network and methods for leveraging a user's content such that actual products and services are bought and sold based on user engagement with a social network. There also is a present need for a network and methods for creating new revenue streams for product and service suppliers.

### SUMMARY OF THE INVENTION

As described herein, the preferred embodiments of the present invention overcome one or more of the above or other disadvantages known in the art. The present invention aims to solve the aforementioned issues, and describes methods and systems for incentivizing user engagement on a social network. More specifically, the invention describes methods for tagging various forms of media on social networks and creating mediums for purchase of goods and services based on the tagging.

In one embodiment, pre-existing or newly created media content on third party social networking systems may be combined and/or accessed via the present social networking systems. Such media may be presented in a singular news feed interface wherein users may be provided the option to tag products and or services depicted in the media. The user tagging may increase user and brand engagement by incentivizing a present purchase, or saving the good or service for use or purchase at a later date by way of a wishlist that is capable of being followed by a plurality of users. In another embodiment, notifications may be sent to third party vendors when a new tag is created, and a relevant advertisement may be served at the discretion of the vendor. Elements of the present invention are described in greater detail below.

In another embodiment, the present social network may include a user profile that comprises of a user's personal details that are unique to each user. Such details may include biographical information, network statistics and interests. The present social network may be linked and or connected to other social networks by way of proprietary API's, or direct links. In one embodiment, the present social network may be a standalone social network that has unique accounts for each user, wherein users may share their information on other popular social networks at the time, as well as the presently described network.

In another embodiment, the present social network may be an active layer that may be implemented on top of currently available systems, wherein the incentivized interaction model is added to sites where various forms of content is shared. Users would be able to maintain their current social network credentials, but third party sites may have the option to add the compensatory schemes mentioned herein as an active layer to their social networking system.

A user may tag various content that may result in incentivizing user engagement. A tagged product or service is a critical component within the presently described social networking system. Once a user has tagged a specific media, the tag is generated and saved in the present social networking system's back-end.

Tags may be created using a plurality of methods. Tag creation begins once media is uploaded. In one embodiment, the tags may be created by using a mobile device's native camera to take a photo, and then tagging the photo with relevant product or service tags. Alternatively, photos maybe uploaded from a user's saved images, for example via the camera roll or gallery of saved images based on a web-search. Notably, anything depicted in the uploaded media may be tagged by the user. A single image may be tagged multiple times if multiple items are present, or if multiple tags are relevant for a single product, a user may provide all possible relevant tags.

In another embodiment, a user may be provided the option to select items in the media to tag. Additionally, the present social networking system may be connected to a database of previously received and verified tags. In this implementation, tags may be auto-generated or suggested to a user for convenience purposes as a search query is inputted into the tagging service.

If the aforementioned database or API calls do not return a match that is satisfactory to the user, an option may be provided to create a new tag. In such cases, users may be provided an option to create a new product, category, or optionally, a service if such option is relevant. In one embodiment, the user may be able to connect the item to the internal point of sale system. In the event that a given product or service is not already part of the aforementioned database or previously recalled goods or services, users may be required to upload media so that a complete record is available for future users.

Scaling the created tags and leveraging them for the dual aims of user and brand engagement rests upon the idea that a first user may create tags. Thereafter, a second user may either follow tags, share tags, like tags, or save items based on the tags for current or future purchase. In an ideal scenario, a second user would purchase the goods and or services related to a tag within a certain nominal time period. A third user can follow then also the second user's transactional history, and make a similar purchasing or saving decision.

In another embodiment, a wish list may be created based on the tags that a user sees within the social networking system. In one embodiment, credits may be provided for unique impressions of a vendors good or service that may in turn be redeemable for goods or services of their own.

In yet another embodiment, users may be incentivized to engage with a plurality of other users because upon creation of a tag, subsequent purchases may only occur if the user has followers, or if the user's profile is public. Such incentive to make money and create influence in a marketplace also promotes a public social networking system rather than implementing a closed off system. Nonetheless, privacy controls may be an optionally provided feature within the present social networking system.

Consequently, users with significant amounts of followers may be incentivized to share, because the rewards can come immediately in the case of a second user purchasing an item or service within a nominal period of time; or over time based on accumulated points and or impressions.

Notably, product and or service chains are created by the present social networking system. In one embodiment, product tags may be followed from their original creation, which would indicate where and when the person created a tag. Thereafter, the scale and history of subsequent purchases would be available for analysis to understand where a particular good or service is being sold, and at what pace.

From the vendor's perspective, such rich information may be used to modify product and service offerings to maximize sales. This feature also acts as a tacit incentive, as users may be credited so long as their original tag resulted in a sale in some influential way. By this method, a user's influence or other point-assignable profile statistic is available to view.

These and other aspects and advantages of the preferred embodiments of the present invention may become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE FIGURES

FIG. 1. Is an illustration of a social network populating a user's profile based on the received feed from various pre-existing sources.

FIG. 2. Depicts the process of a user tagging elements in a media.

FIG. 3. Is an illustration of a product database receiving product data from various pre-existing sources.

FIG. 4A. Illustrates how a user may add a relevant tag to the image.

FIG. 4B. Shows how a search query the may auto-populate potential search matches.

FIG. 4C. Illustrates an updated newsfeed once a user has provided tags to images.

FIG. 5. Illustrates a user creating a “wish list” by selecting elements in a media.

FIG. 6. Is a flow diagram illustrating the process of verifying and creating tags.

### DETAILED DESCRIPTION OF THE PREFERRED EMBODIMENTS

Reference will now be made in detail to the preferred embodiments of the present invention, examples of which are illustrated in the accompanying drawings.

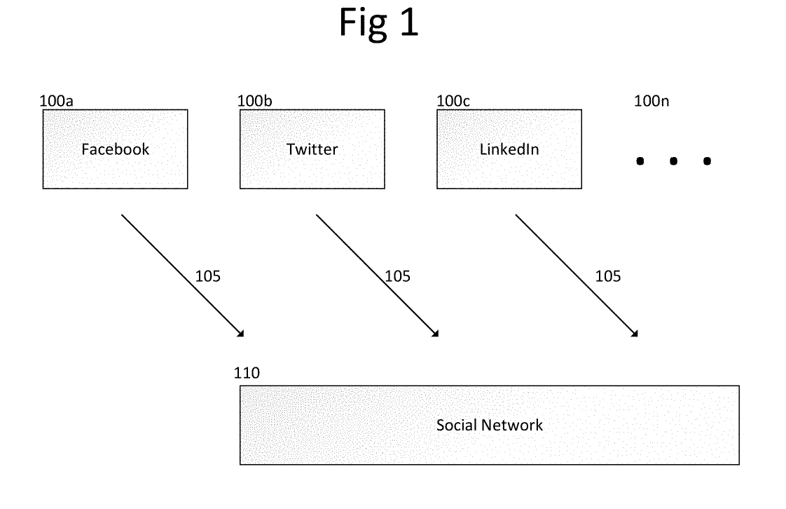

FIG. 1 illustrates a social network 110 populating a user's profile based on the received user data feed 105 from various pre-existing social network sources 100abcn. Pre-existing sources may include, among others 100n, social networks that presently exist such as Facebook 100a, Twitter 100b, LinkedIn 100c. A plurality of third party social networks 100abc or any individual data source 100n may be utilized to provide a user's data 105 to the social network of present invention 110. Such data streams 105 may include various login credentials such as a user name and password. The data stream 105 may also include personal information such as profile pictures, friends lists, as well as other elements, available in the preexisting social networks 100abc, so that a user's social media presence across various social networks may be unified. Finally, the user data stream 105 may include media files (e.g. pictures, videos, etc.) that are ready to be tagged in the present social network 110.

Optionally, the present invention 110 may include the option to share information on pre-existing social networks 100abc used for login purposes. Such postings may include a simple status or post update that indicates for example: “I'm using LeafIt, come follow me!”, and further include a link that is customized for that user. The link may further provide a unique identifier to be used as a referral to keep track of who was the originator of the new unique user. Connecting the present invention with Facebook 100a, for example, may provide the user with the option to allow the present invention to access a user's public profile, friend list and email address. Users may have the option to select one external network to connect with, or preferably, multiple networks.

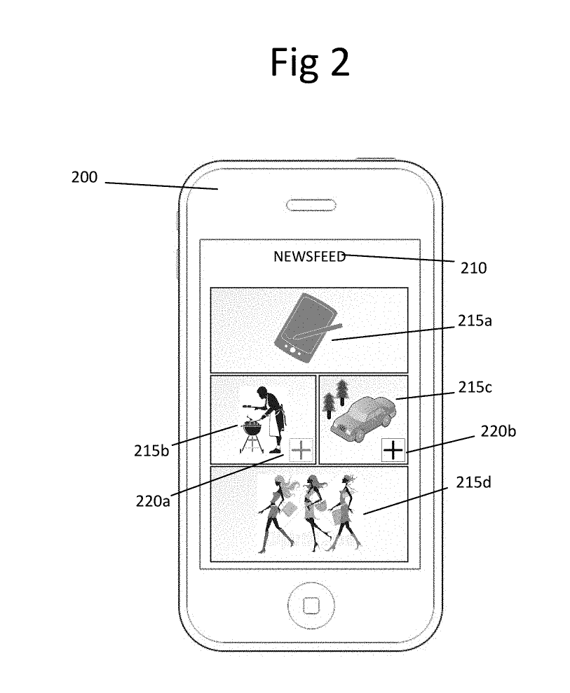

FIG. 2 illustrates a potential newsfeed on a mobile device 200. The primary news feed 210 may house all images compiled and presented from the various social networks 100a to 100n from FIG. 1. Images compiled from a plurality of users' social networking accounts may be cropped and squared up with a plus icon 220a or 220b, as shown in the bottom right, encouraging users to add tags. The location of the plus icon 220a or 220b may be replaced, and a different type of symbol other than a plus icon may be used. By way of example, larger images such as 215a and 215d have already been tagged, and therefore span the width of the mobile device's 200 screen. This brings attention to products that have already been tagged by users and thus increasing a tagged product or service's visibility while also potentially increasing user engagement. Images such as 215b and 215c have not been tagged, and therefore appear resized and take up a smaller portion of the screen in the newsfeed 210. Users are provided the option 220a and 220b to provide tags. Once appropriate tags are added, images 215b and 215c may increase in size and span the size of the screen such as in 215a. By clicking or selecting the plus icon on a piece of media, the associated image may increase in size. If the image is already tagged, a user may be provided the option to add it to a personal list, or share it with their various networks.

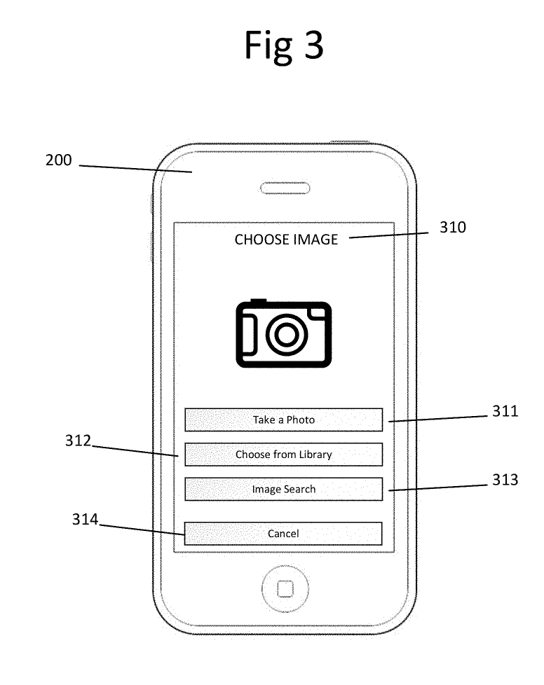

FIG. 3 illustrates how a user may upload new media on a mobile device 200 via a choose image menu 310. For example, the available options may include options to take a photo 311, to choose a photo from a library 312, to search the web for an image 313, or to cancel the process 314. In other words, users may potentially take a new photo, choose from their personal library, or search online for a relevant image. Once an option is selected, users may be provided the option to upload the selected image, no matter what the original source of the image is. This new media file may then be presented in an updated newsfeed 210.

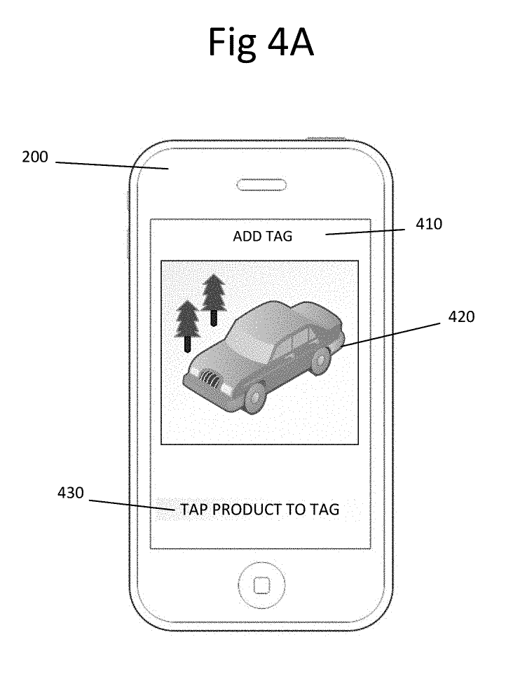

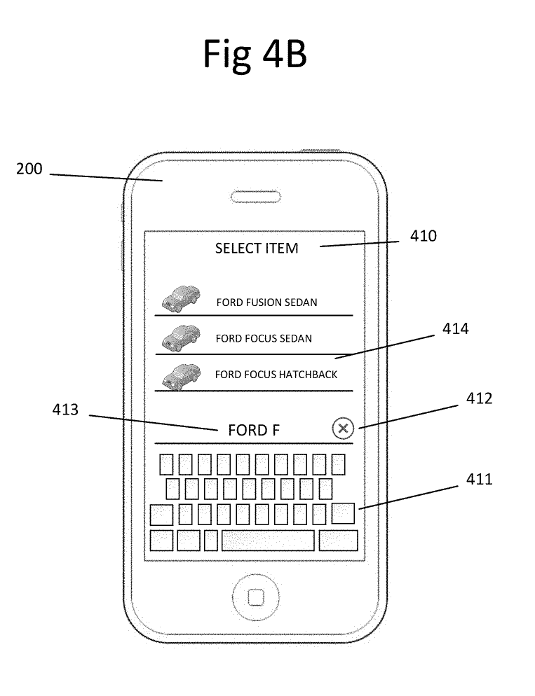

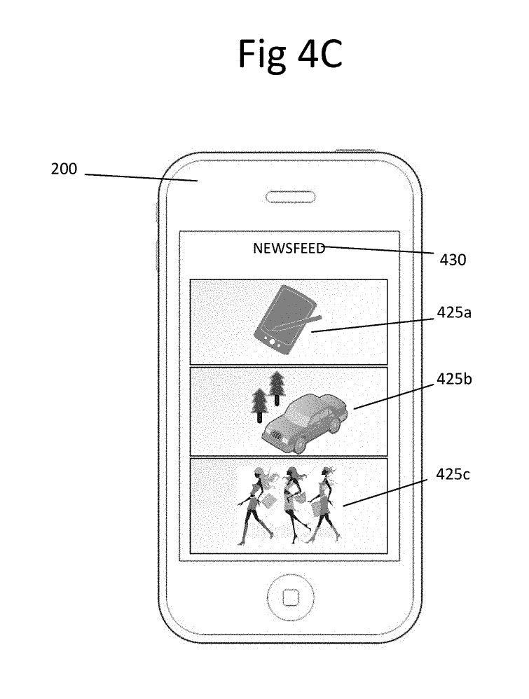

FIG. 4A illustrates how a user may add a relevant tag to the image 420 on a mobile device 200. This process works whether the image has been previously tagged, or if this the image or has no tags. The user may be presented the option 430 to select location on an image 420, and thereafter prompted with option 410 to add a tag. Notably, images may have a number of relevant and irrelevant items depicted. For example, image 420 shows a car, but also shows trees to the adjacent left of the car. In the instant case, it would be up to the user to determine what is a relevant item from a piece of media, such as the car shown in 420.

FIG. 4B further illustrates how a user may tag a selected image 420. A keyboard 411 whether physical or via a touch interface may be used to enter a potential search query for tagging a selected item 410. As the user types in letters 413 in the search query field 412, the interface may auto-populate potential search matches 414. The user could type in the name, type, and or brand name of the product in search query field 412. As the user types 413, a list of potential tags is populated for the user to choose from 414. In the event that a user has entered data and there is no match, the user may be presented with a message indicating that a match has not been found. The user may then have the option to search again, or create a new tag.

FIG. 4C illustrates an updated newsfeed 430, once a user has provided tags to images. In this updated newsfeed, the tagged products 425abc now span the entire width of the screen. Notably, single pictures or uploaded media may contain multiple products. Accordingly, each product may require its own tag. For example, in image 425c, people are shown in conjunction with other products, such as shoes, dresses, and purses. It is up to the user to decide whether to tag one of the products, all of the products, or none of the products.

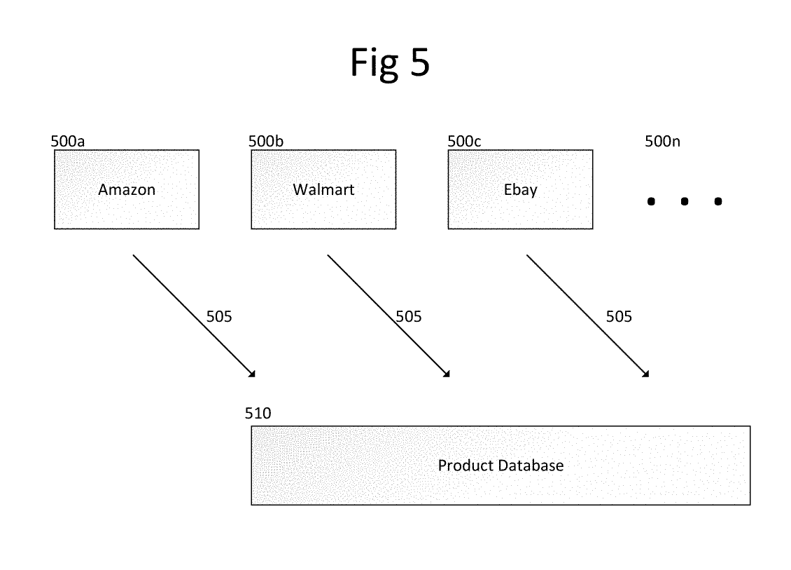

FIG. 5. Illustrates a product database 510 receiving product data 505 from various pre existing sources 500abc. Third party sites such as Amazon.com 500a and various other e-commerce sites such as Walmart 500b or eBay 500c are also depicted, respectively. Users of the present social network system 110 may be presented with the option to purchase an item that is depicted in a newsfeed 210. In one embodiment, the tagged item 215abc in a newsfeed 210 may then link to another screen, where the user or the user's followers may purchase the product or service. The second screen may present a plurality of vendors, and indicate the price and optionally shipping costs and time associated with the respective product. Users may also be able to select a preferred vendor from their options, and therefore may only be presented with the vendors that they prefer. Using certain vendors may also provide further incentive such as points or feedback credits. The products from the various vendors 500n may be available in a product database 510, which may be compiled and moderated for relevance. The product database 510 may also be used for the creation of tags and may also serve as a tag repository.

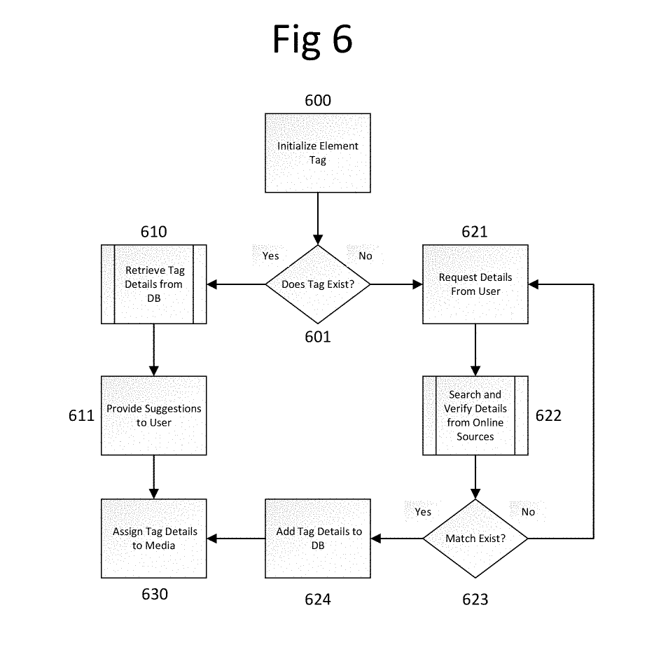

FIG. 6. Is a flow diagram illustrating the process of adding and verifying tags. When the user is ready to add a new tag 410, the system may initialize a tag element 600. The present system may then query 601 whether a tag exists. In the event that a tag based on the query already exists on the database, a plurality of tags details 610 may be retrieved to provide suggestions 611 to the user. The user may then determine which tags 630 to assign to the products, services, and other commercially relevant materials. In the event that no matching tags exist 601, the system may request details from the user 621 and provide a search to verify the details from online sources 622. If a match still does not exist, the system may recursively request details 621 from the user until a match is made (i.e. a “yes” occurs at decision 623). Once a match exists, tag details 624 may be added to the database and assigned 630 to the media.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A social networking method comprising the steps of:
establishing an online networking environment to enable a plurality of users to engage in the sharing of media;
providing a user interface in the online networking environment to enable a first user with a first option to,
upload a media file that may visually depict a commercially relevant material, select at least a first tag from a populated list of tags, and
associate said first tag with a first commercially relevant material displayed in the media file;
providing the first user with a second option to create a tag associated with the displayed; and
furnishing credit to users of the online networking environment that tag images with relevant links to commercially relevant material.

2. The social networking method of claim 1 wherein the commercially relevant material is a product.

3. The social networking method of claim 1 wherein the commercially relevant material is a service.

4. The social networking method of claim 1, wherein the populated list of tags reside in a maintained online repository.

5. The social networking method of claim 1, where if no pre-existing tag exists in the populated list of tags, a tag is suggested based upon an input by the user.

6. The social networking method of claim 1, wherein the furnished credit consists of monetary compensation, online reputation points or discounts on a plurality of tagged goods or services.

7. The social networking method of claim 1, wherein the populated list of tags link to a point of sale system.

8. The social networking method of claim 1, wherein the networking environment is interfaced with other online social networking platforms via an API.

9. The social networking method of claim 1, wherein users can login to said online networking environment using previously registered credentials from other social networks.

10. The social network method of claim 1, further comprising the steps of:
enabling a second user to generate a tag on the first user's uploaded file with links to locations for purchase of commercially relevant material based on the material depicted in the first user's uploaded file; and
furnishing credit to the second user as originator of the newly generated tag.

11. The social networking method of claim 1, wherein the online networking environment comprises of multiple online networking environments being displayed within the interface of the present invention.

12. The social networking method of claim 1, wherein users may save tags and add them to a profile associated with their name, resulting in a list that may be followed and shared by a plurality of users.

13. The social networking method of claim 1, wherein users are provided privacy options to publicly share their tags.

14. A social networking system comprising:
a communication network and;
a plurality of client devices connected to the communication network, whereby each of the plurality of client devices offers a user interface to engage in social networking activity, and wherein, the user interface of a first client device enables a first user of the social networking activity to:
upload an image file that may depict or reference a product and/or service;
select at least one tag from a populated list of tags and associate it with a commercially relevant material depicted in the image file, and if there is no pre-existing tag in the populated list of tags, providing the first user with a second option to create a tag associated with the displayed commercially relevant material; and
incentivizing users of the online networking environment to tag images with relevant links to commercially relevant material to receive credit.

15. The social networking system of claim 11, wherein the populated list of tags reside in a maintained online repository.

16. The social networking system of claim 11, wherein the received credit may comprise of monetary compensation, online reputation points or discounts on a plurality of tagged commercially relevant materials.

17. The social networking system of claim 12, wherein the populated list of tags also link to a point of sale system.

18. The social networking system of claim 12, wherein the networking environment is connected to other online social networking platforms via an API.

19. The social networking system of claim 12, wherein users can login to said online networking environment using previously registered credentials from other online networks.

20. The social network system of claim 11, further comprising the steps of:
enabling a second user to tag the first user's image file with links to commercially relevant material when the first user fails to provide a tag; and
providing credit to the second user as originator of the tag.
